(19) United States
(12) Patent Application Publication
(10) Pub. No.: US 2010/0265194 A1
(43) Pub. Date: Oct. 21, 2010

(54) HAND-HELD DEVICE INCLUDING A TOUCH SCREEN AND MENU DISPLAY METHOD

(75) Inventor: LIAN-DONG LIU, Tu-Cheng (TW)

Correspondence Address: Altis Law Group, Inc.;ATTN: Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/730,246

(22) Filed: Mar. 24, 2010

(30) Foreign Application Priority Data
Apr. 20, 2009 (CN) 200910301679.7

(51) Int. Cl. G06F 3/041; G06F 3/048

(52) U.S. Cl. 345/173; 715/835

(57) ABSTRACT

A hand-held device including a touch screen includes a detection module and a user interface control module. The touch screen displays content, and receives a slide input. After detecting the slide input, the detection module records slide area information of the slide input, and determines if the slide input corresponds to a menu display command. If the slide input corresponds to the menu display command, the user interface control module controls the touch screen to display icons of menu options related to the content in the slide area allowing a user to see the menus related to the content and ease of selection of the menus.

### BACKGROUND

1. Technical Field

The disclosure relates to hand-held devices, and particularly to a hand-held device including a touch screen and menu display method.

2. Description of Related Art

Hand-held devices, such as, mobile phones and personal digital assistants, are incorporated with a plurality of functions, for example, communication, music, and calendar functions. Thus, a plurality of menus and items may be needed for selection of corresponding functions. If a user wants to use a function, he/she can find corresponding icons of the menu or item option, and then select it to implement the function.

Icons of menu options are displayed on displays of hand-held devices. Thus, for users of a hand-held device including a touch screen, operations using a single hand are difficult, in addition, the users need to constantly bend and stretch fingers, which is inconvenient.

### BRIEF DESCRIPTION OF THE DRAWINGS

FIG. 1 is a schematic diagram of an embodiment of a hand-held device including a touch screen as disclosed.

FIGS. 2 and 3 are schematic diagrams illustrating one embodiment of menu display in a slide area of the hand-held device including a touch screen of FIG. 1.

FIG. 4 is a flowchart illustrating one embodiment of a menu display method as disclosed.

### DETAILED DESCRIPTION

In general, the word “module,” as used herein, refers to logic embodied in hardware or firmware, or to a collection of software instructions, written in a program language. In one embodiment, the program language may be Java or C. One or more software instructions in the modules may be embedded in firmware, such as an EPROM. The modules described herein may be implemented as either software and/or hardware modules and may be stored in any type of computer-readable medium or other storage device.

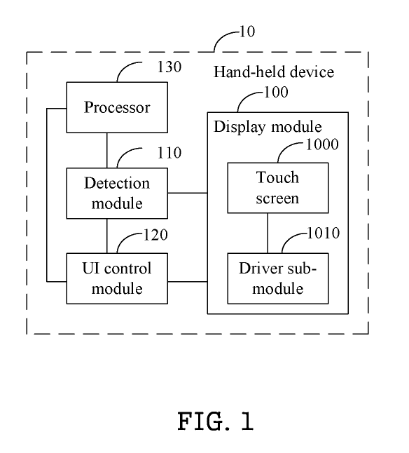

FIG. 1 is a schematic diagram of an embodiment of a hand-held device 10 including a touch screen as disclosed. The hand-held device 10 may be a mobile phone, a personal digital assistant, or a digital camera including a touch screen, which can be operated with fingers or a stylus. In one embodiment, the hand-held device 10 includes a display module 100, a detection module 110, a user interface (UI) control module 120, and a processor 130.

The display module 100 includes a touch screen 1000 and a driver sub-module 1010. The touch screen 1000 displays various content, such as text and video, and receives inputs on the touch screen 1000 to operate the hand-held device 10. In one embodiment, the inputs include slide inputs and pressing inputs. In one embodiment, the slide input may be defined as a finger or stylus depressing on or sliding above the touch screen 1000 in a series succession, while the pressing input may be defined as a single depression on the touch screen 1000 using a finger or stylus. The driver sub-module 1010 drives the touch screen 1000 to display content.

The detection module 110 is connected to the touch screen 1000, and detects the inputs on the touch screen 1000 and records area information of the inputs. In one embodiment, the detection module 110 detects the slide inputs on the touch screen 1000, and records slide area information of the slide inputs, for example, coordinates of the area of the slide inputs of the touch screen 1000. The detection module 110 determines if the slide inputs correspond to menu display commands, and sends the menu display commands and the slide area information to the UI control module 120 if the slide inputs correspond to menu display commands. In one embodiment, the detection module 110 includes capacitive detectors. It is understood that the inclusion of the detection module 110 is exemplary and may be variable depending on the embodiment. For example, the detection module 110 may also include resistive detectors. The menu display commands may correspond to menu selection of an operating system or an application of the hand-held device 10.

In one embodiment, the slide area information comprises coordinates of the slide area on the touch screen 1000. The detection module 110 determines if the slide inputs are continuous according to the coordinates of the slide area to determine if the slide inputs correspond to menu display commands. If the slide inputs are continuous, that is, there in no interruption in the slide inputs, the detection module 110 determines that the slide inputs correspond to the menu display commands

In one embodiment, the slide inputs corresponding to the menu display commands may be continuous inputs from one side to the other side of the touch screen 1000. For example, for a right-handed user, the slide inputs corresponding to the menu display commands may be a continuous input from a bottom side to a right side of the touch screen 1000 or from a left side to a right side of the touch screen 1000. Thus, the detection module 110 determines if the slide inputs correspond to the menu display commands according to if the slide inputs are from one side to another side of the touch screen 1000. It is understood that the areas of the slide inputs corresponding to the menu display commands are exemplary and may be variable depending on the embodiments. For example, the slide inputs corresponding to the menu display commands may correspond to inputs that have distances exceeding a predetermined distance.

The UI control module 120 is connected to the detection module 110 and the display module 100, and receives the menu display commands and the slide area information if the slide inputs correspond to the menu display commands. The UI control module 120 controls the touch screen 1000 to display icons of menu options related to current content displayed by the touch screen 1000 in the slide area. The UI control module 120 controls the touch screen 1000 to display icons of different menu options according to different current content, which may be set according to actual needs. For example, if the current content displayed by the touch screen 1000 is an idle image, the icons of menu options related to the idle image may include icons of phone book, short message, camera, music, for example, which can be set by users. If the current content displayed by the touch screen 1000 is a photo, the icons of menu options related to the photo may include items of delete, add, zoom in, zoom out, for example

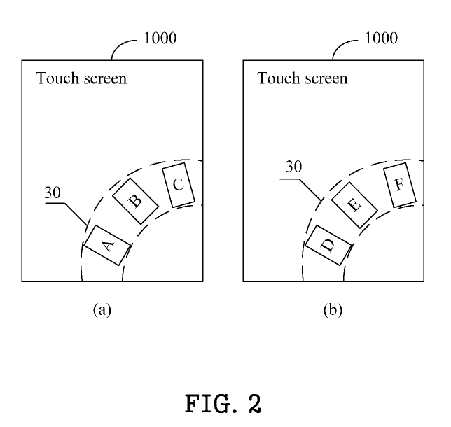

The UI control module 120 controls the touch screen 1000 to display the icons of commonly-used menus related to the current content in the slide area. In alternative embodiments, the UI control module 120 controls the touch screen 1000 to display the icons of the all menu options related to the current content in the slide area. Because the slide area is limited and the icon numbers of the all menu options can be big, the UI control module 120 controls the touch screen 1000 to circularly display the icons of the all menu options related to the current content in the slide area in a normal size according to the slide area information. That is, some icons are displayed in the slide area at this time, and other icons are displayed in the slide area next time. For example, as shown in FIG. 2, it is supposed that a user of the hand-held device 10 is a right-handed user and a slide input corresponding to the menu display command may be slid from a bottom side to a right side of the touch screen 1000. That is, an area 30 with broken lines is the slide area. Suppose that there are six icons A to F, thus, at first, the UI control module 120 controls the touch screen 1000 to display icons A to C with a normal size in the slide area 30, and then controls the touch screen 1000 to display icons D to F with a normal size in the slide area 30. However, it may be understood that a left-handed user may operate the hand-held device 10 in a similar manner.

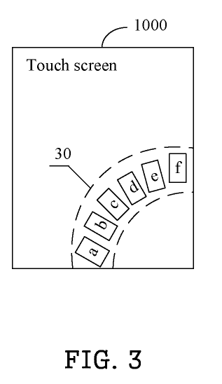

The UI control module 120 may also dynamically adjust the sizes of the icons of the all menu options according to the slide area information, and control the touch screen 1000 to simultaneously display all size-adjusted icons in the slide area. As shown in FIG. 3, the UI control module 120 controls the touch screen 1000 to simultaneously display icons a to f in the slide area 30, which have smaller size than those of icons A to F in FIG. 2.

The processor 130 executes one or more computerized instructions for the detection module 110 and the UI control module 120.

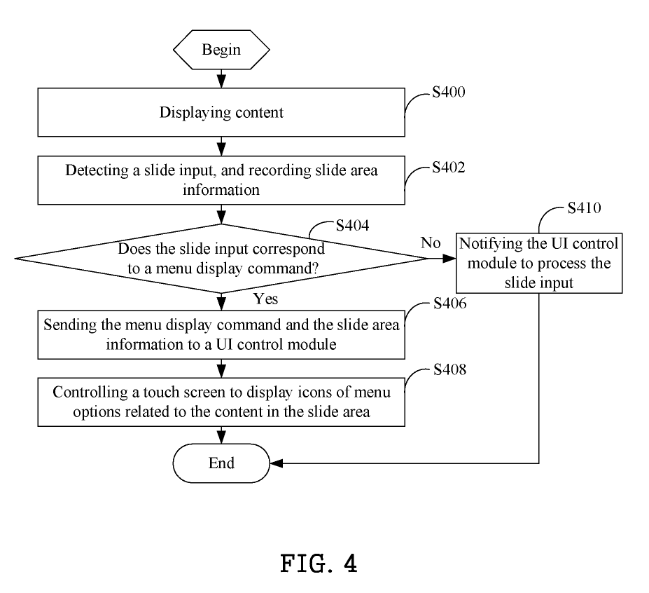

FIG. 4 is a flowchart illustrating one embodiment of a menu display method of the hand-held device 10 as disclosed. Suppose that the hand-held device 10 is idle, first, in block S400, the touch screen 1000 displays an idle image. If a user wants to see menus related to the idle image, the user slides a finger on the touch screen 1000 from a bottom side to a right side of the touch screen 1000. Then in block S402, the detection module 110 detects a slide input, and records slide area information of the slide input including coordinates of the slide area of the touch screen 1000. In block S404, the detection module 110 determines if the slide input corresponds to a menu display command according to the slide area information. In one embodiment, the detection module 110 determines if the slide input is continuous according to the coordinates of the slide area, and determines if the slide input corresponds to the menu display command accordingly.

If the slide input corresponds to the menu display command, in block S406, the detection module 110 sends the menu display command and the slide area information to the UI control module 120.

In block S408, the UI control module 120 controls the display module 100 to display icons of menu options related to the idle image in the slide area for selections. In one embodiment, the icons of menu options related to the idle image may include the icons of phone book, short message, camera, music, for example. The menu options related to the idle image may include commonly-used menu options and all menu options. The all menu options may be circularly displayed in the slide area in a normal size, as shown in FIG. 2. In alternative embodiments, the UI control module 120 may also dynamically adjust the sizes of the icons of the all menu options, and control the display module 100 to display the size-adjusted icons in the slide area simultaneously, as shown in FIG. 3.

If the detection module determines that the slide input does not correspond to the menu display command, in block S410, the detection module 110 notifies the UI control module 120 to process the slide input.

The hand-held device 10 and the menu display method make slide inputs on the hand-held device 10 with single hand possible, and further make the menu display in the slide area. Thus, menu selections with single hand are achieved, which is convenient. In addition, users only need to move fingers without bending or stretching, which brings further convenience for users.

The foregoing disclosure of various embodiments has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto and their equivalents.

What is claimed is:

1. A hand-held device, comprising:
a display module comprising a touch screen to display content and to receive inputs on the touch screen, the inputs comprising slide inputs;
a detection module to detect the slide inputs, record slide area information of the slide inputs on the touch screen, and to determine if the slide inputs correspond to menu display commands;
a user interface (UI) control module to control the touch screen to display icons of menu options related to current content displayed by the touch screen in the slide area if the slide inputs correspond to the menu display commands; and
a processor to execute one or more computerized instructions for the detection module and the UI control module.

2. The hand-held device of claim 1, wherein the UI control module controls the touch screen to just display the icons of commonly-used menu options related to the current content displayed by the touch screen in the slide area.

3. The hand-held device of claim 1, wherein the UI control module controls the touch screen to display the icons of all menu options related to the current content displayed by the touch screen in the slide area.

4. The hand-held device of claim 3, wherein the UI control module controls the touch screen to circularly display the icons of the all menu options in a normal size.

5. The hand-held device of claim 3, wherein the UI control module dynamically adjusts the sizes of the icons of the all menus options according to the slide area information, and controls the touch screen to display all size-adjusted icons in the slide area simultaneously.

6. The hand-held device of claim 1, wherein the slide area information comprises coordinates of the slide area of the touch screen.

7. The hand-held device of claim 6, wherein the detection module determines if the slide inputs are continuous according to coordinates of the slide area so as to determine if the slide inputs correspond to menu display commands.

8. The hand-held device with touch screen of claim 7, wherein the detection module determines the slide inputs correspond to the menu display commands under the condition of the slide inputs being continuous.

9. A menu display method of a hand-held device comprising a touch screen, comprising:
detecting a slide input on the touch screen, and recording slide area information of the slide input;
determining if the slide input corresponds to a menu display command; and
controlling the touch screen to display icons of menu options related to current content displayed by the touch screen in the slide area if the slide input corresponds to a menu display command.

10. The menu display method of claim 9, wherein the slide area information comprises coordinates of the slide area of the touch screen.

11. The menu display method of claim 10, wherein determining if the slide input corresponds to a menu display command comprises:
determining if the slide input is continuous according to the coordinates of the slide area; and
determining that the slide input corresponds to the menu display command under the condition of the slide input being continuous.

12. The menu display method of claim 9, wherein controlling the touch screen to display icons of menu options related to current content displayed by the touch screen in the slide area comprises:
controlling the touch screen to display the icons of commonly-used menu options related to the current content displayed by the touch screen in the slide area.

13. The menu display method of claim 9, wherein controlling the touch screen to display icons of menu options related to current content displayed by the touch screen in the slide area comprises:
controlling the touch screen to display the icons of all menu options related to the current content displayed by the touch screen in the slide area.

14. The menu display method of claim 13, wherein controlling the touch screen to display the icons of the all menu options related to the current content displayed by the touch screen in the slide area comprises:
dynamically adjusting sizes of the icons of the all menu options according to the slide area information; and
controlling the touch screen to display all size-adjusted icons in the slide area.

15. The menu display method of claim 13, wherein controlling the touch screen to display the icons of all menu options related to the current content displayed by the touch screen in the slide area comprises:
controlling the touch screen to circularly display the icons of the all menu options related to the current content in the slide area in normal size.

16. The menu display method of claim 9, wherein further comprising:
sending the menu display command and the slide area information to a user interface control module if the slide input corresponds to the menu display command.
